(19) United States
(12) Patent Application Publication
(10) Pub. No.: US 2024/0351134 A1
(43) Pub. Date: Oct. 24, 2024

(54) METHOD FOR FRICTION-JOINING GALVANIZED STEEL SHEETS, AND JOINED STRUCTURE

(71) Applicant: OSAKA UNIVERSITY, Osaka (JP)

(72) Inventors: Hidetoshi FUJII, Osaka (JP); Yoshiaki MORISADA, Osaka (JP); Hiroki FUJIMOTO, Tokyo (JP); Hiroyuki HIRATA, Tokyo (JP); Shinji KODAMA, Tokyo (JP)

(21) Appl. No.: 18/684,478

(22) PCT Filed: Aug. 3, 2022
(86) PCT No.: PCT/JP2022/029779

§ 371 Date: Feb. 16, 2024

(30) Foreign Application Priority Data
Aug. 20, 2021 (JP) 2021-134687

(51) Int. Cl. B23K 20/12; B23K 103/04

(52) U.S. Cl. CPC B23K 20/1205; B23K 20/129; B23K 2103/04

(57) ABSTRACT

Provided are: a method for friction-joining galvanized steel sheets in which admixture of zinc into a joined part is effectively suppressed, and with which it is possible to obtain a joined part that is coated with a galvanized layer; and a joined structure obtained through the aforementioned joining method. A friction-joining method characterized by having a first step for bringing one member into contact with another member to form a joining interface, a second step for repeatedly causing the one member and the other member to slide on the same trajectory in a state in which pressure is applied substantially perpendicularly to the joining interface and eliminating burrs from the joining interface, and a third step for stopping the sliding and forming a joined surface, the friction-joining method also being characterized in that the one member and/or the other member is configured as a galvanized steel sheet, and in that admixture of a galvanized component into the joined surface is suppressed due to the elimination of the burrs.

### TECHNICAL FIELD

The present invention relates to a friction-joining method for solid-state joining galvanized steel sheets and a joined structure obtained by the friction-joining method.

### BACKGROUND ART

Steel materials are used in various industrial products because they have excellent strength and ductility and are inexpensive. On the other hand, since there is the disadvantage of being easily corroded, hot-dip galvanized steel sheets, whose surfaces are galvanized, are used in corrosive environments.

However, when welding galvanized steel sheets, zinc, which has a boiling point lower than the melting point of steel, turns into zinc vapor, making it difficult to achieve a good welding condition. Specifically, due to the zinc vapor, there is a case that blowholes or the like may be formed in the bead, or a case that the state of arc formation may become unstable, resulting in increased spatter generation.

Furthermore, since during fusion welding, the zinc plating on the surface evaporates to change the surface condition of the galvanized steel sheet, the corrosion resistance is deteriorated. In addition, there is another problem in that the mechanical properties and reliability of the joint deteriorate due to mixing of zinc into the welded portion.

On the other hand, for example, Patent Document 1 (Japanese Unexamined Patent Publication No. 2016-179483) discloses a welding method of a galvanized steel sheet includes: a step for preparing a galvanized steel sheet, a step for forming an arc between the galvanized steel sheet and a welding wire, heating and melting the galvanized steel sheet and the welding wire while performing shielding with shield gas, and forming a molten pool, and a step for solidifying the molten pool, and the shield gas is a mixed gas which comprises carbon dioxide, argon and the remainder consisting of inevitable impurities, and a diameter of the welding wire is 0.9 mm or less and carbon dioxide contained in the shield gas is 4% by volume or more and 10% by volume or less, or the diameter of the welding wire is larger than 0.9 mm and 1.0 mm or less and carbon dioxide contained in the shield gas is 4% by volume or more and 6% by volume or less.

In the method for welding galvanized steel sheets described in Patent Document 1, it is said that a method for welding galvanized steel sheets that can achieve a good welded state can be provided by optimizing the proportion of carbon dioxide contained in the shielding gas and the diameter of the welding wire, which have a large effect on the welding condition of the galvanized steel sheets.

Further, Patent Document 2 (Japanese Unexamined Patent Publication No. 2015-167981) discloses a welding method of a galvanized steel sheet is characterized in that, in the method of welding the galvanized steel sheet according to an MAG welding method, a low-viscosity solid wire which reduces viscosity of a molten pool as a welding wire and a three kinds of mixed gases consisting of 13 to 18% by volume of oxygen gas, 5 to 15% by volume of carbon dioxide gas and a remainder of argon gas are used as shield gas.

In the method for welding galvanized steel sheets described in Patent Document 2, it is said that, in place of the high viscosity wire commonly used when MAG welding galvanized steel sheets, by using a low-viscosity solid wire that can lower the viscosity of the molten pool, it is possible to make it easier for the zinc vapor generated during welding to escape from the molten pool, and by using a ternary system of argon gas (Ar), carbon dioxide gas (CO₂), and oxygen gas (O₂) as the optimal shielding gas composition when performing MAG welding by using the low-viscosity solid wire, and mixing these into a predetermined composition ratio, it is possible to obtain an effect for suppressing the occurrence of a blow hole and a pit to a welded portion without deteriorating a mechanical strength of welded metal with a preferable reproducibility.

### PRIOR ART REFERENCE

### Patent Document

Patent Document 1: Japanese Unexamined Patent Publication No. 2016-179483
Patent Document 2: Japanese Unexamined Patent Publication No. 2015-167981

### SUMMARY OF THE INVENTION

### Problem to be Solved by the Invention

However, in the methods for welding galvanized steel sheets disclosed in Patent Document 1 and Patent Document 2 mentioned above, since the galvanized layer in the welded portion is completely vaporized, it is impossible to obtain a welded portion covered with a good galvanized layer. Further, since the vaporized zinc is inevitably mixed into the welded portion, it is extremely difficult to suppress deterioration in the mechanical properties of the joined portion due to the mixing.

In view of the above-mentioned problems in the prior art, an object of the present invention is to provide a method for joining the galvanized steel sheet that effectively suppresses the mixing of zinc into the joined portion and provides a joined portion covered with a galvanized layer, and another object is to provide a joined structure obtained by the method.

### Means to Solve the Problems

In order to achieve the above object, the present inventors have done intensive study as to joining methods for galvanized steel sheets, and have found the fact that it is extremely effective that the friction-joining methods such as linear friction-joining and friction-joining are applied to the joining of galvanized steel sheets to prevent zinc from mixing into the joined portion by discharging burrs from the joined interface, and have reached the present invention.

Namely, the present invention provides a friction-joining method which comprises:
a first step of forming an interface to be joined by bringing an end surface of one member into contact with an end surface of the other member while applying a pressure substantially perpendicular to the interface to be joined;
a second step of repeatedly sliding the one member and the other member on the same trajectory to discharge burr from the interface to be joined; and
a third step of stopping the sliding to form a joined surface;
wherein at least one of the one member and the other member is a galvanized steel sheet, and
the discharge of the burr suppresses the mixing of galvanizing components into the joined surface.

In the method for friction-joining of the present invention, principles such as linear friction-joining and friction-joining for discharging burrs from the joined interface can be used, and in the following, the linear friction-joining will be described in detail as a representative method.

FIG. 1 is a schematic diagram which shows the situation during the linear friction-joining method (linear friction-joining). The linear friction-joining is a solid phase joining in which the frictional heat generated when the materials to be joined are rubbed against each other by linear motion is the main heat source. The material softened by the temperature rise is discharged as burrs from the interface to be joined to remove the oxide film formed on the interface to be joined, and the new surfaces are brought into contact with each other to obtain the joined portion.

Here, although the burr is first discharged from the interface to be joined in the direction approximately perpendicular to the direction of sliding, it is subsequently discharged from the direction approximately parallel to the sliding direction, and then finally the burr is discharged from the entire circumference of the interface to be joined. That is, even if the zinc plating evaporates or melts during the joining, it is possible to effectively suppress contamination of the galvanizing components into the joined portion. In particular, when linearly friction-joining the galvanized steel sheets, by linearly sliding the sheets in the direction perpendicular to the sheet thickness, the burrs can be quickly discharged from the long sides, which occupy most of the surface of the joined portion, and the contamination of the galvanized components into the joined portion can be very effectively suppressed.

Further, as a result of the present inventors' detailed observation of the linear friction joined portion of the galvanized steel sheets, it has been clearly found that the galvanized layer formed on the surface of the steel sheet deforms and/or moves following suitably softened burrs, so the linear friction joined portion is covered with a galvanized layer up to the root of the burr. That is, by using the linear friction-joining, not only the contamination of zinc into the joined portion can be suppressed, but also the surface of the joined portion can be sufficiently covered with the galvanized layer.

The type, size, and shape of the galvanized steel sheet to which the friction-joining method of the present invention is applied are not particularly limited as long as the effects of the present invention are not impaired, and various conventionally known galvanized steel sheets can be used.

In the friction-joining method of the present invention, it is preferable that the pressure is set to equal to or higher than the yield stress of the galvanized steel sheet at a desired joining temperature, and the joining temperature is set to equal to or lower than the boiling point of zinc. In linear friction-joining or friction pressure joining, the joining temperature can be accurately determined by the joining pressure, but by setting the joining temperature below the boiling point of zinc, it is possible to suppress changes in the galvanized layer formed on the surface of the steel sheet.

Here, in the present invention, “joining temperature” means “the desired highest temperature reached at the interface to be joined in the second step.”

Further, in the friction-joining method of the present invention, it is preferable that the joining temperature is set to equal to or lower than the melting point of zinc plating. By setting the joining temperature to equal to or lower than the melting point of the zinc plaiting, changes in the galvanizing layer formed on the surface of the steel sheet can be more effectively suppressed.

Further, in the friction-joining method of the present invention, it is preferable that the joining temperature is set to equal to or lower than the A₁ point of the galvanized steel sheet. By setting the joining temperature to equal to or lower than the A₁ point of the galvanized steel sheet, not only can the joining temperature be reliably set to equal to or lower than the boiling point of zinc, but also it is possible to suppress the softening and embrittlement of the steel sheet. In the steel material, there is a case that brittle martensite is formed by phase transformation to make joining difficult and to make the joined portion brittle. On the other hand, when the joining temperature is set to the A₁ point or less, since any phase transformation does not occur, the formation of the brittle martensite can be completely suppressed. In addition, by lowering the joining temperature, softening in the heat-affected zone can be suppressed.

Here, the frictional heat increases when the applied pressure of the linear friction-joining (friction-joining) is increased, but since the softened material becomes burrs and is continuously discharged, the “joining temperature” is determined by the pressure (force to discharge burrs) which is applied to the softened material. That is, when the applied pressure is set high, the material to be joined with higher strength (state with high yield strength) can be discharged as burrs. Here, since the “state with higher yield strength” means the “state with lower temperature”, the “joining temperature” decreases as the applied pressure increases. Since the relationship between the yield strength and the temperature is substantially constant depending on the material, the joining temperature can be controlled extremely accurately compared to the case where frictional heat is used.

Furthermore, in the friction-joining method of the present invention, it is preferable that the tensile strength of the galvanized steel sheet is 340 MPa or more. The friction-joining method of the present invention is a solid phase welding method, and even using steel sheets having high tensile strength, a joined portion having high strength and excellent reliability can be obtained. Further, since the joining temperature is set to a low value to effectively suppress the mixing of zinc plating, it is possible to develop good joint characteristics with suppressed softening of the heat-affected zone even when high-strength steel sheets are used.

Further, the present invention provides a joined structure which has a friction joined portion where the one member and the other member are integrated via a friction joined interface, and at least one of the one member and the other member is a galvanized steel sheet, and the zinc plating component is not mixed into the friction joined portion. The shape and size of the galvanized steel sheet are not particularly limited, and include a wide range of materials such as plate materials, square-shaped members (prismatic columns), U-shaped members, and pipe materials.

Here, “zinc plating component is not mixed into the linear friction joined portion” can be confirmed by, for example, performing elemental analysis by using SEM-EDS on a cross section of the joined portion. Here, the method of SEM-EDS measurement is not particularly limited, and may be performed by using various conventionally known devices and measurement conditions. More specifically, elemental mapping may be obtained for the cross section of the joined portion to confirm whether or not an element originating from the galvanized layer present on the surface of the joined portion are mixed into the inside of the joined portion. The permissible content of the zinc plating components in the joined portion depends on the steel material used as the base material, but it is sufficient as long as it does not affect the strength of the steel material, for example, 1.0% by mass as an average value in the joined portion, and more preferably the maximum value at the joined portion is also less than 1.0% by mass. The joint efficiency of the friction joined portion is preferably 90% or more, more preferably 95% or more, and most preferably 100%.

Further, in the joined structure of the present invention, it is preferable that the burr is formed at the outer edge of the friction joined interface, and that the surface of the friction joined portion is coated with the galvanized layer up to the root of the burr. Since the surface of the linear friction joined portion is coated with the galvanized layer up to the root of the burr, it is possible to realize a joined portion having excellent corrosion resistance.

### Effects of the Invention

According to the present invention, there is provided a method for joining the galvanized steel sheet that effectively suppresses the mixing of zinc into the joined portion and provides a joined portion covered with a galvanized layer, and another object is to provide a joined structure obtained by the method.

### BRIEF DESCRIPTION OF THE DRAWINGS

FIG. 1 is a schematic diagram which shows one embodiment of the friction-joining method (linear friction-joining) of the present invention.

FIG. 2 is a schematic diagram which shows joining steps of the friction-joining method (linear friction-joining) of the present invention.

FIG. 3 is a graph which shows the deformation stress (yield stress) of carbon steel at each temperature.

FIG. 4 is a graph which shows the tensile strength of various metals at each temperature.

FIG. 5 is a schematic cross-sectional view which shows one example of the joined structure of the present invention.

FIG. 6 is a graph which shows the temperature dependence of the strength of hot-dip galvanized steel sheets used in Examples.

FIG. 7 is an appearance photograph and a cross-sectional photograph of the joined portion obtained in Example (200 MPa).

FIG. 8 is an SEM photograph and elemental mapping of the cross section of the hot-dip galvanized steel sheet used in Examples.

FIG. 9 is an SEM photograph and elemental mapping of the cross section of the joined portion obtained in Examples (200 MPa).

FIG. 10 is a schematic diagram which shows the shape and dimensions of the tensile test piece used in Examples.

FIG. 11 is a stress-strain diagram which shows the tensile properties of joints obtained in Examples.

FIG. 12 is a cross-sectional photograph of the joined portion of the 1.2 mm thick steel sheet obtained in Example.

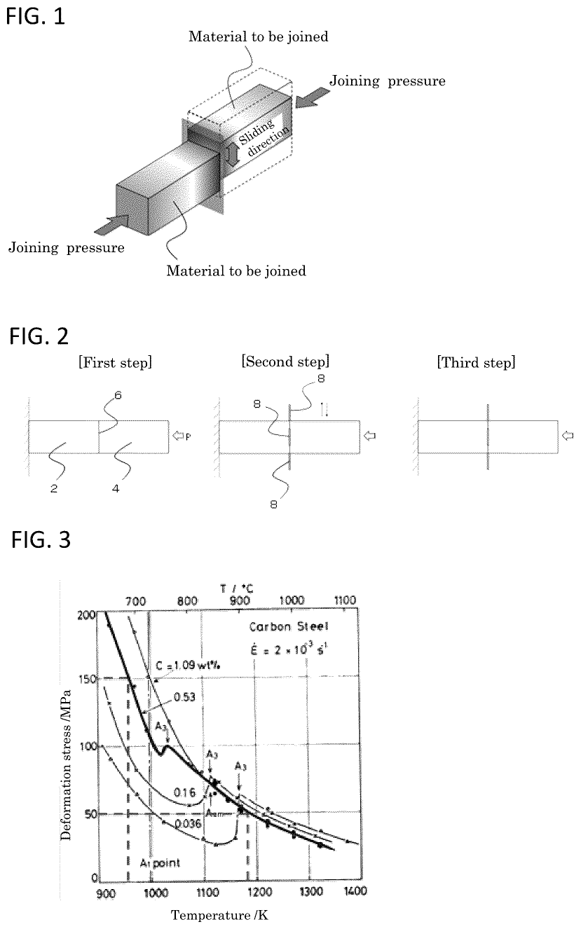

### MODE FOR CARRYING OUT THE INVENTION

In the following, by referring the drawings, the typical embodiments of the linear friction-joining method and the joined structure of the present invention are explained, but the present invention is not limited thereto. In the following explanation, the same symbol is given to the same or corresponding parts, and there is a case where overlapping explanation is omitted. In addition, since these drawings are presented to explain the concept of the present invention, there are cases where size and ratio of the structural elements are different from the real case.

### (1) Friction-Joining Method

FIG. 2 is a schematic diagram which shows the joining step of the friction-joining method of the present invention when the linear friction-joining is used. The friction-joining method of the present invention includes of a first step of bringing the one member 2 into contact with the other member 4 to form an interface 6 to be joined, a second step of repeatedly sliding the one member 2 and the other member 4 on the same locus a state while applying a pressure substantially perpendicular to the interface 6 to be joined to discharge the burr 8 from the interface to be joined substantially parallel to and substantially perpendicular to the sliding direction, and a third step of forming a joining surface by stopping the sliding. Hereinafter, each step will be described in detail.

### (1-1) First Step

The first step is a step of bringing the one member 2 into contact with the other member 4 to form an interface 6 to be joined. The one member 2 and/or the other member 4 is moved to a position where the formation of the joined portion is desired, and the surfaces to be joined are brought into contact with each other to form the interface 6 to be joined.

At least one of the one member 2 and the other member 4 is a galvanized steel sheet. The type, size and shape of the galvanized steel sheet are not particularly limited as long as the effects of the present invention are not impaired, and various conventionally known galvanized steel sheets can be used. Examples of the galvanized steel sheets include hot-dip galvanized steel sheets (GI), galvannealed steel sheets (GA), electrogalvanized steel sheets (EG) and double-layer alloyed galvanized steel sheets (GAE), and, a similar method can be applied to galvanized steel sheets having different compositions, such as highly corrosion-resistant hot-dip zinc-aluminum-magnesium alloy coated steel sheets (ZAM (registered trademark), Superdyma (registered trademark): high climate-resistant coated steel sheets), zinc-aluminum alloy coated steel sheets, zinc-nickel alloy coated steel sheets, zinc-magnesium coated steel sheets. Further, in each galvanized steel sheet, the coating weight (plating thickness) is not particularly limited as long as the effects of the present invention are not impaired, and can be set to various conventionally known values.

The mechanical properties of the galvanized steel sheet used as the material to be joined are not particularly limited as long as the effects of the present invention are not impaired, and it is preferable that the tensile strength is 340 MPa or more. Even when a steel sheet having high tensile strength is used, the joined portion having high strength and excellent reliability can be obtained. Further, since the joining temperature is set to a low value to effectively suppress the mixing of zinc plating, it is possible to develop good joint characteristics with suppressed softening of the heat-affected zone even when high-strength steel sheets are used. A more preferable tensile strength of the galvanized steel sheet is 780 MPa or more, and the most preferable tensile strength is 980 MPa or more.

### (1-2) Second Step

The second step is a step of repeatedly sliding the one member 2 and the other member 4 on the same locus a state while applying a pressure P substantially perpendicular to the interface 6 to be joined to discharge the burr 8 from the interface 6 to be joined substantially parallel to and substantially perpendicular to the sliding direction.

The method of repeatedly sliding the one member 2 and the other member 4 on the same locus is not particularly limited as long as the effect of the present invention is not impaired, and may be a method in which both members are vibrated together, or a method in which one is vibrated while the other is fixed.

Here, in the present invention, the joining temperature can be controlled by setting the pressure P at the time of the linear friction-joining to be equal to or higher than the yield stress of the one member and/or the other member and equal to or lower than the tensile strength at a desired joining temperature. In the friction-joining method of the present invention, by setting the pressure P to be equal to or higher than the yield stress and lower than the tensile strength of the hot-dip galvanized steel sheet at the desired joining temperature, the joining temperature can be determined based on the hot-dip galvanized steel sheet. When the pressure P is set to be equal to or higher than the yield stress of the hot-dip galvanized steel sheet, the discharge of burrs 8 from the interface 6 to be joined is started, and when the pressure P is increased up to the tensile strength, the discharge of burrs 8 is accelerated. Similar to the yield stress, since the tensile strength at a specific temperature is substantially constant depending on the material to be joined, the joining temperature corresponding to the set pressure P can be realized. Further, thereby, it is possible to join thin sheets without deforming the base material. For example, the sheet thickness is preferably 2.0 mm or less.

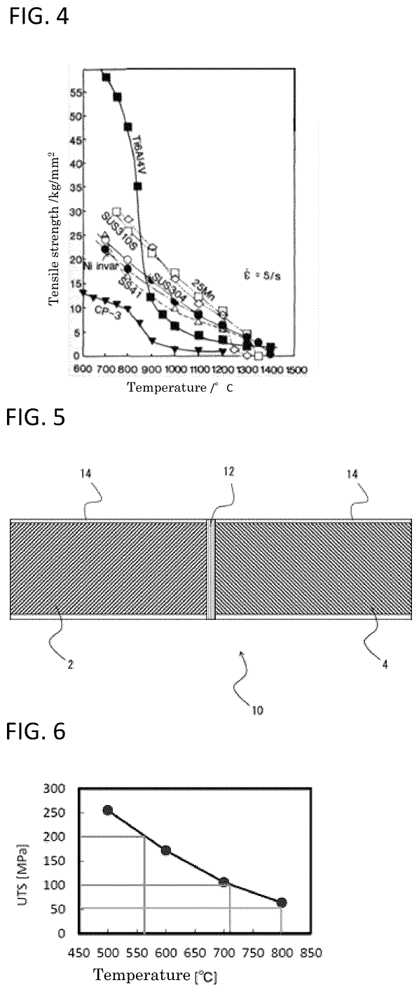

As a specific example, FIG. 3 shows the deformation stress (yield stress) of the carbon steel at each temperature, and FIG. 4 shows the tensile strength of various metals at each temperature. FIG. 3 is a graph published in “Iron and Steel, No. 11, the 67^{th year (}1981), p. 140”, and FIG. 4 is a graph published in “Iron and Steel, No. 6, the 72^{th} year (1986), p. 55”. As shown in these figures, the tensile strength and yield stress at a specific temperature are substantially constant depending on the material. That is, by creating a database of such data for the materials to be joined, it is possible to efficiently and easily perform the joining at any temperature.

When the pressure P at the time of joining is set high, the material to be joined (hot-dip galvanized steel sheets) having higher yield strength and tensile strength can be discharged as burrs, and the joining temperature can be lowered. Further, as shown in FIG. 3 and FIG. 4, since the tensile strength and the yield stress at a specific temperature are substantially constant depending on the material, by setting the joining pressure P on the basis of the temperature dependence of the strength of the hot-dip galvanized steel sheet the joining temperature of the hot-dip galvanized steel sheet can be controlled extremely accurately.

In the linear friction-joining, it is necessary to set joining parameters (frequency and amplitude for exciting the material to be joined, joining time, burn-off length, and the like) other than the pressure P, but these values are not limited as long as the effect of the present invention is not impaired, and may be appropriately set depending on the property, shape, size and the like of the material to be joined. Here, though the rate of temperature rise increases by increasing the amplitude and frequency at which the material to be joined is slid, the maximum temperature reached (joining temperature) does not change.

The joining temperature is preferably set to equal to or lower than the boiling point of zinc (907° C.), and more preferably set to equal to or lower than the melting point of zinc plating (when alloyed, set to equal to or lower than the melting point of the alloyed plating). In linear friction-joining, the joining temperature can be accurately determined by the joining pressure P, but by setting the joining temperature to equal to or lower than below the boiling point of zinc, it is possible to suppress changes in the galvanized layer formed on the surface of the steel sheet. Further, by setting the joining temperature to equal to or lower than the melting point of the zinc plaiting, changes in the galvanized layer can be suppressed more reliably.

Further, in the friction-joining method of the present invention, it is preferable that the joining temperature is set to equal to or lower than the A₁ point of the galvanized steel sheet. By setting the joining temperature to equal to or lower than the A₁ point of the galvanized steel sheet, not only can the joining temperature be reliably set to equal to or lower than the boiling point of zinc, but also it is possible to suppress the softening and embrittlement of the steel sheet. In the steel material, there is a case that brittle martensite is formed by phase transformation to make joining difficult and to make the joined portion brittle. On the other hand, when the joining temperature is set to the A₁ point or less, since any phase transformation does not occur, the formation of the brittle martensite can be completely suppressed. In addition, by lowering the joining temperature, softening in the heat-affected zone can be suppressed.

### (1-3) Third Step

The third step is a step of stopping sliding in the second step to form a joined surface. In the friction-joining method of the present invention, a good joined article can be obtained by stopping the sliding after the burrs 8 are discharged from the entire surface of the interface 6 to be joined. Further, by discharging the burr 8 from the entire surface of the interface 6 to be joined, it is possible to suppress the zinc plating components from entering the joined portion. Note that, the pressure P applied to the material to be joined in the second step may be maintained as it is, or may be set to a higher value for the purpose of discharging the burr 8 and making the new surface being brought into contact more strongly. There is a case where the joining area increases in the joining process to decrease the pressure P, which results in unintentional increase of the joining temperature, but the phenomenon can be suppressed by increasing the pressure P.

Here, the timing to stop the sliding is not limited as long as the burr 8 has been discharged from the entire surface of the interface 6 to be joined, but, while observing the interface 6 to be joined from the direction substantially perpendicular to the sliding direction, by stopping the sliding at the moment when the burr 8 is discharged approximately parallel to the sliding direction, it is possible to form a good joined portion, while the amount of burr 8 discharged can be minimized (the consumption of the material to be joined can be minimized). Note that both the “direction substantially perpendicular to the sliding direction” and the “direction substantially parallel to the sliding direction” are substantially perpendicular to the applied pressure.

### (2) Joined Structure

FIG. 5 is a schematic cross-sectional view which shows one example of the joined structure of the present invention. In the joined structure 10, the one member 2 and the other member 4 are linearly friction joined, and at least one of the one member 2 and the other member 4 is a hot-dip galvanized steel sheet.

The one member 2 and the other member 4 are metallurgically joined via the linear friction joined portion 12, and the linear friction joined portion 12 is characterized by being free of contaminant of the galvanized layer 14 formed on the surface of the hot-dip galvanized steel sheet. It is sufficient to confirm that “zinc plating components are not mixed in the linear friction joined portion” by elemental analysis with SEM-EDS on the cross section of the joined portion, but, since the quantitative value of zinc causes an error due to the peak derived from iron, for example, elemental mapping may be obtained for the entire cross section of the joined portion, and the determination may be made based on whether or not a clear location of zinc is shown inside the joined portion.

In the joined structure 10, it is preferable that the burr 8 is formed at the outer edge of the linear friction joined interface (interface 6 to be joined), and that the surface of the linear friction joined portion 12 is coated with the galvanized layer 14 up to the root of the burr 8. Since the surface of the linear friction joined portion 12 is coated with the galvanized layer 14 up to the root of the burr 8, it is possible to realize a joined portion having excellent corrosion resistance.

Although the typical embodiments of the present invention have been described above, the present invention is not limited to these, and various design changes are possible, and all of these design changes are included in the technical scope of the present invention. For example, such a case that, when the joining temperature exceeds the boiling point of zinc the zinc vapor is applied to the surface of the joined body may be included.

### Example

Using a hot-dip galvanized steel sheet (JIS-SGHC: 0.05% C-0.01% Si-0.15% Mn-0.17% P-0.04% S) as the material to be joined, the hot-dip galvanized steel sheets were subjected to the linear friction-joining by butting the ends of the sheets together.

The size of the hot-dip galvanized steel sheet is 2 mm×50 mm×63 mm, and the butted end surfaces are 2 mm×50 mm.

Further, in order to determine the joining pressure of the linear friction-joining, the temperature dependence of the strength of the hot-dip galvanized steel sheets was investigated by using a high-temperature tensile test. The tensile strengths were measured at 500° C., 600° C., 700° C. and 800° C., and the obtained results are shown in FIG. 6. From the results in FIG. 6, 50 MPa, 100 MPa, and 200 MPa were set as the joining pressures at which the joining temperature during the linear friction-joining was below the boiling point of zinc (907° C.). The predicted joining temperatures at each joining pressure are 50 MPa: approximately 800° C., 100 MPa: approximately 700° C., and 200 MPa: approximately 560° C.

The conditions of the linear friction-joining other than the joining pressure were kept constant at a frequency of 50 Hz, an amplitude of 2 mm, and a burn-off length of 2.5 mm. When the temperature of the hot-dip galvanized steel sheet surface at the position 1 mm from the interface to be joined was measured by using a K-type thermocouple when using each joining pressure, the results were 50 MPa: approximately 605° C., 100 MPa: approximately 566° C., 200 MPa: approximately 330° C. The temperature decreased as the joining pressure increased, which corresponds to the results in FIG. 6. Note that since the temperature measuring position is 1 mm away from the joining interface, the actually measured value is lower than the value predicted from FIG. 6.

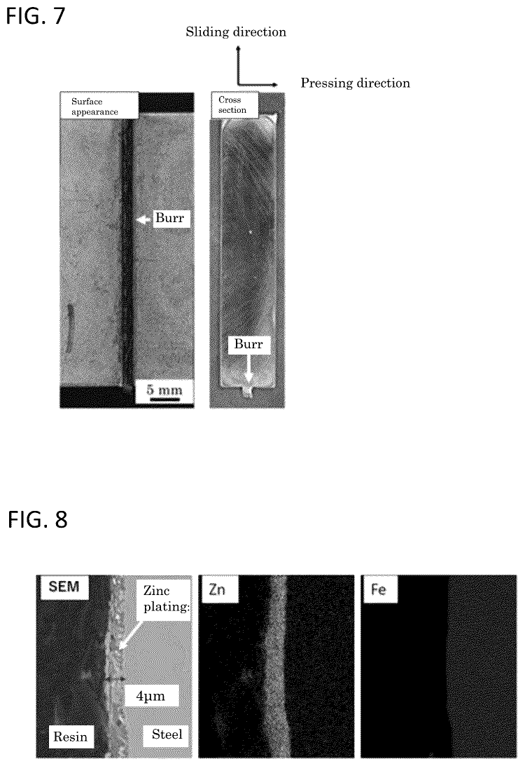

In all the joined portions obtained at each joining pressure, the discharge of the burrs was observed from the entire circumference of the interface to be joined. Further, in cross-sectional observation of all the joined portions, no joining defect such as unjoined portion or crack was observed. As a representative result, the appearance photograph and the cross-sectional photograph of the joined portion obtained at 200 MPa are shown in FIG. 7. In the appearance photograph, it can be seen that the surface condition of the hot-dip galvanized steel sheet (the condition of the galvanized layer) has hardly changed up to the vicinity of the burr.

Next, SEM-EDS analysis of the cross section of the joined portion was performed for all the joined portions obtained at each joining pressure. Further, in order to confirm the initial state of the hot-dip galvanized layer, SEM-EDS analysis of the cross section of the hot-dip galvanized steel sheets before joining was also performed. Note that JSM-7001FA available from JEOL Ltd. was used for the SEM.

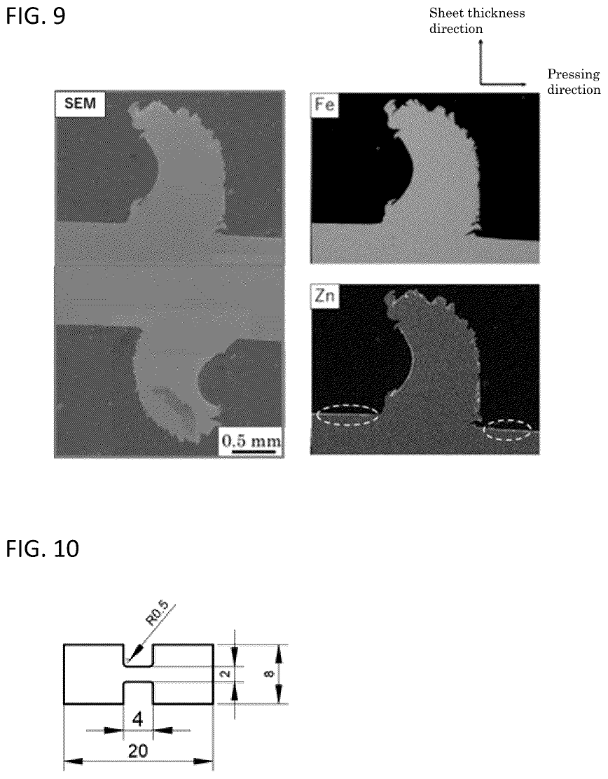

FIG. 8 shows the SEM photograph and elemental mapping results of the hot-dip galvanized steel sheet before joining. It can be seen that the galvanized layer having a thickness of about 4 μm is formed on the surface of the steel sheet. As a typical result of the joined portion, the SEM photograph and elemental mapping results of a joined portion obtained at 200 MPa are shown in FIG. 9. From the mapping results of zinc (Zn), no contamination of zinc is found in the joint. In addition, it can be confirmed that the surface of the joined portion is covered with the galvanized layer up to the root of the burr (area surrounded by dotted lines in the figure). Note that, in the joined portions obtained at 50 MPa and 100 MPa, as similar to the joined portion obtained at 100 MPa, no contamination of zinc is found in the joint, and the surface of the joined portion was covered with the galvanized layer up to the root of the burr.

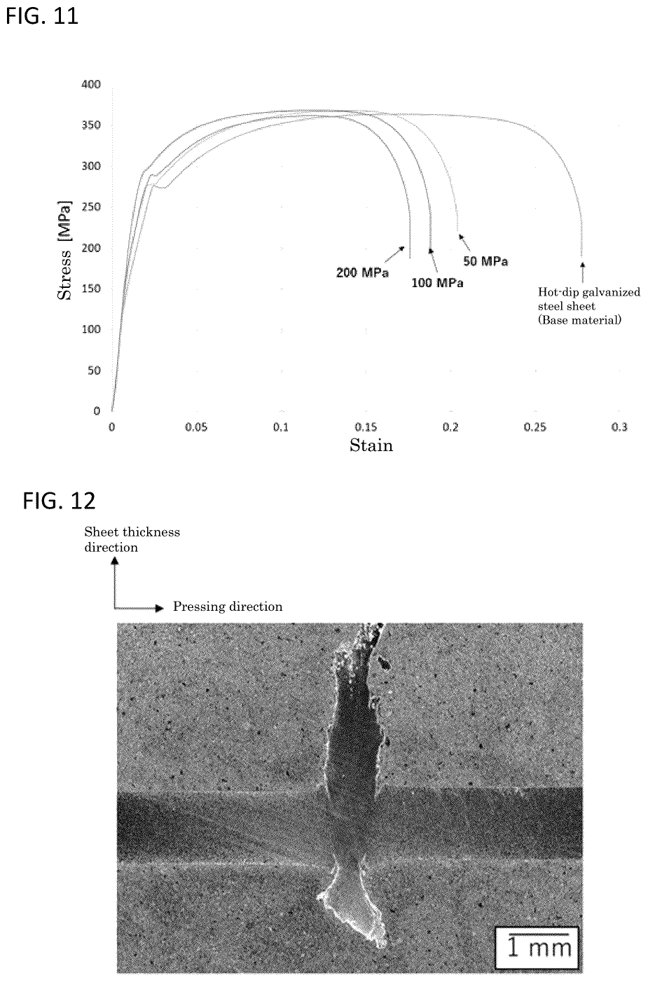

In order to evaluate the mechanical properties of the joined portion, tensile tests were performed on the joined portion obtained at each joining pressure and on the hot-dip galvanized steel sheets before joining. The test piece shown in FIG. 10 was prepared so that the joined interface was located at the center of the parallel portion, and the tensile axis was set perpendicular to the joined interface. The tensile strength of the joint was measured by using a tensile tester (SHIMADZU Autograph AGS-X 10 kN) at a crosshead speed of 0.06 mm/min. FIG. 11 shows stress-strain diagrams obtained at each joining pressure.

The joined portions obtained at any joining pressure exhibited the tensile strength equivalent to that of the hot-dip galvanized steel sheets before joining, and the base metal fractured. Regarding the elongation, the value of the joined portion is slightly smaller, but this is thought to be due to the increase in hardness because of the refinement of the structure of the linear friction joined portion.

The linear friction-joining was performed at a joining pressure of 50 MPa in the same manner as in the case where the sheet thickness was 2.0 mm, except that the thickness of the hot-dip galvanized steel sheet used as the material to be joined was 1.2 mm. A cross-sectional photograph of the joined portion of the obtained joint is shown in FIG. 12. Even when the sheet thickness was 1.2 mm, a good burr discharge from the interface to be joined was confirmed, and it can be seen that the same joined portion was formed as the case that the sheet thickness was 2.0 mm.

From the above results, by using the linear friction-joining, it is possible to suppress the contamination of the galvanized layer components into the joined portion, and also to obtain a joint in which the surface of the joined portion is covered with the galvanized layer, and it can be seen that tensile properties equivalent to those of the base material can be imparted.

### EXPLANATION OF SYMBOLS

2 . . . One member,
4 . . . Other member,
6 . . . Interface to be joined,
8 . . . Burr,
10 . . . Joined structure,
12 . . . Linear friction joined portion,
14 . . . Galvanized layer.

The invention claimed is:

1. A friction-joining method which comprises:
a first step of forming an interface to be joined by bringing an end surface of one member into contact with an end surface of the other member while applying a pressure substantially perpendicular to the interface to be joined;
a second step of repeatedly sliding the one member and the other member on the same trajectory to discharge burr from the interface to be joined; and
a third step of stopping the sliding to form a joined surface;
wherein at least one of the one member and the other member is a galvanized steel sheet, and
the discharge of the burr suppresses the mixing of galvanizing components into the joined surface.

2. The friction-joining method according to claim 1, wherein
the pressure is set to equal to or higher than the yield stress of the galvanized steel sheet at a desired joining temperature, and
the joining temperature is set to equal to or lower than the boiling point of zinc.

3. The friction-joining method according to claim 1, wherein the joining temperature is set to equal to or lower than the melting point of zinc plating.

4. The friction-joining method according to claim 1, wherein the joining temperature is set to a point A₁ of the galvanized steel sheet or lower.

5. The friction-joining method according to claim 1, wherein the tensile strength of the galvanized steel sheet is 340 MPa or more.

6. A joined structure which comprises a friction joined portion where the one member and the other member are integrated via a friction joined interface,
at least one of the one member and the other member is a galvanized steel sheet,
and the galvanizing component is not mixed into the friction joined portion.

7. The joined structure according to claim 6, wherein a burr is formed at the outer edge of the friction joined interface, and that the surface of the friction joined portion is coated with the galvanized layer up to the root of the burr.
